(19) United States
(12) Patent Application Publication
(10) Pub. No.: US 2007/0113781 A1
(43) Pub. Date: May 24, 2007

(54) Flame spraying process and apparatus

(76) Inventor: George Jay Lichtblau, Ridgefield, CT (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/267,694

(22) Filed: Nov. 4, 2005

(51) Int. Cl. B05B 5/025

(52) U.S. Cl. 118/620

(57) ABSTRACT

A process, apparatus and material composition for forming a coherent refractory mass on a surface wherein one or more non-combustible materials are mixed with one or more metallic combustible powders and an oxidizer, igniting the mixture in a combustion chamber so that the combustible metallic particles react in an exothermic manner with the oxidizer and release sufficient heat to form a coherent mass of material under the action of the heat of combustion, and projecting this mass against the surface so that the mass adheres durably to the surface. The combustion chamber can be operative with a reverse vortex to cool the walls of the chamber.

### CROSS REFERENCE TO RELATED APPLICATIONS

This application is related to U.S. patent application Ser. No. 10/948,420 filed Sep. 23, 2004 and incorporated herein by reference.

### STATEMENT REGARDING FEDERALLY SPONSORED RESEARCH OR DEVELOPMENT

N/A

### BACKGROUND OF THE INVENTION

The “flame spray” or “thermal spray” process has been well documented and described in the prior literature. As described in U.S. Pat. No. 6,001,426: “Thermal spraying is a process of applying coatings of high performance materials, such as metal, alloys, ceramics and carbides, onto more easily worked and cheaper base materials. The purpose of the coating is to provide enhanced surface properties to the cheaper bulk material of which the part is made.” As also stated in the same patent: “Thermal spray includes a variety of approaches, but can be grouped into three main coating processes: combustion, wire-arc, and plasma.” Such thermal spray processes can be further subdivided into continuous and detonation processes.

All of these known thermal spraying processes have one thing in common: they all use an external energy source to provide the heat to soften or melt the material that is to be sprayed. In addition, the rate of deposition of these thermal spraying processes is relatively low and there is a need for higher spray rates.

The traditional flame spray processes use either a gas fuel (hydrogen) and oxygen mixture for the heat source or a high-powered electric arc. The hydrogen-oxygen heat source requires large high-pressure tanks of both gases, while the electric arc typically requires 55 Kilowatts of electric power (Sulzermetco F4 Gun Series).

One of the problems with the present thermal spraying process is the difficulty of controlling the chemical environment and preventing oxidation reactions which can occur on the surface of the powder particles prior to their impingement on the substrate.

It will be helpful to describe the present types of flame spray processes. These descriptions are available on the web site of the Gordon England Company in the UK, www.gordonengland.co.uk.

Combustion Powder Thermal Spray Process:

This process, also called the Low Velocity Oxygen Fuel Process (LVOF), is basically the spraying of molten material onto a surface to provide a coating. Material in powder form is melted in a flame (oxy-acetylene or hydrogen most common) to form a fine spray. When the spray contacts the prepared surface of the substrate material, the fine molten droplets rapidly solidity forming a coating.

The main advantage of this flame spray process over the similar Combustion wire spray process is that a much wider range of materials can be easily processed into powder form giving a larger choice of coatings. The flame spray process is only limited by materials with higher melting temperatures than the flame can provide or if the material decomposes on heating.

Combustion Wire Thermal Spray Process (Metal Spraying):

This flame spray process is basically the spraying of molten metal onto a surface to provide a coating. Material in wire form is melted in a flame (oxy-acetylene flame most common) and atomized using compressed air to form a fine spray. When the spray contacts the prepared surface of a substrate material, the fine molten droplets rapidly solidify forming a coating.

This flame spray process has been extensively used in the past and today for machine element work and anti-corrosion coatings.

Plasma Spray Process:

The Plasma Spray Process is basically the spraying of molten or heat softened material onto a surface to provide a coating. Material in the form of powder is injected into a very high temperature plasma flame, where it is rapidly heated and accelerated to a high velocity. The hot material impacts on the substrate surface and rapidly cools forming a coating.

The plasma spray gun comprises a copper anode and tungsten cathode, both of which are water cooled. Plasma gas (argon, nitrogen, hydrogen, helium) flows around the cathode and through the anode which is shaped as a constricting nozzle. The plasma is initiated by a high voltage discharge which causes localized ionization and a conductive path for a DC arm to form between the cathode and anode. The resistance heating from the arc causes the gas to reach extreme temperature, dissociate and ionize to form a plasma. The plasma exits the anode nozzle as a free or neutral plasma flame (plasma which does not carry electric current) which is quite different from the Plasma Transferred Arc coating process where the arc extends to the surface to be coated. Powder is fed into the plasma flame most commonly via an external powder port mounted near the anode nozzle exit.

Plasma spraying has the advantage over combustion processes in that plasma spraying can spray very high melting point materials such as refractory metals like tungsten and ceramics like zirconia. Plasma sprayed coatings are generally much denser, stronger and cleaner than other thermal spray processed with the exception of HVOF and detonation processes.

Disadvantages of the plasma spray process are its relatively high cost, complexity of the process, slow deposition rate and large amounts of electricity required.

Wire-Arc Spray Process:

In the Wire-Arc Spray Process a pair of electrically conductive wires are melted by means of an electric arc. The molten material is atomized by compressed air and propelled towards the substrate surface. This is one of the most efficient methods of producing thick coatings. “In the two-wire arc process, two insulated metallic wire electrodes are continuously fed to an arc point where a continuously flowing gas stream is used to atomize and spray the molten electrode material in the arc. Some configurations utilize a single feed wire and non-consumable electrode” (U.S. Pat. No. 6,001,426).

Electric arc spray coatings are normally denser and stronger than their equivalent combustion spray coatings. Low running costs, high spray rates and efficiency make it a good tool for spraying large areas and high production rates.

Disadvantages of the electric arc spray process are that only electrically conductive wires can be sprayed and if the substrate requires preheating, a separate heating source is needed.

High Velocity Oxygen Fuel (HVOF) Thermal Spray Process:

The HVOF thermal spray process is basically the same as the Combustion Powder Spray Process (LVOF) except that this process has been developed to produce extremely high spray velocity. There are a number of HVOF guns which use different methods to achieve high velocity spraying. One method is basically a high pressure water cooled HVOF combustion chamber and a long nozzle. Fuel (kerosene, acetylene, propylene and hydrogen) and oxygen are fed into the chamber the chamber, combustion produces a hot high pressure flame which is forced down a nozzle increasing in velocity. Powder may be fed axially into the HVOF combustion chamber under high pressure or fed through the size of a laval type nozzle where the pressure is lower.

The coatings produced by HVOF are similar to those produced by the detonation process. HVOF coatings are very dense, strong and show low residual tensile stress or in some cases compressive stress, which enable very much thicker coating to be applied than previously possible with other processes.

Detonation Thermal Spraying Process:

The Detonation gun basically consists of a long water cooled barrel with inlet valves for gases and powder. Oxygen and fuel (acetylene most common) is fed into the barrel along with a charge of powder. A spark is used to ignite the gas mixture and the resulting detonation heats and accelerates the powder to supersonic velocity down the barrel. A pulse of nitrogen is used to purge the barrel after each detonation. This process is repeated many times per second. The high kinetic energy of the not powder particles on impact with the substrate result in a build up of a very dense and strong coating.

For reference a copy of Table 3 from U.S. Pat. No. 6,001,426 is presented which compares existing thermal spray technologies.

TABLE 3
Comparison of thermal spray technologies.

Flame powder: Powder feedstock, respirated into the oxygen/fuel-gas
flame, is melted and carried by the flame onto the workpiece. Particle
velocity is relatively low, and bond strength of deposits is low.
Porosity is high and cohesive strength is low. Spray rates are usually
in the 0.5 to 9 kg/h (1 to 20 lb/h) range. Surface temperatures can
run quite high.
Flame wire: In flame wire spraying, the only function of the flame is
to melt the material. A stream of air then disentigrates the molten
material and propels it onto the workpiece. Spray rates for materials
such as stainless steel are in the range of 0.5 to 9 kg/h (1 to 20
lb/h). Substrate temperatures are from 95 to 205° C. (200 to
400° F.) because of the excess energy input required for
flame melting.
Wire arc: Two consumable wire electrodes are fed into the gun, where
they meet and form an arc in an atomizing air stream. The air flowing
across the arc/wire zone strips off the molten metal, forming a high-
velocity spray stream. The process is energy efficient all input
energy is used to melt the metal. Spray rate is about 2.3 kg/h/kW
(5 lb/h/kW). Substrate temperature can be low because energy input
per pound of metal is only about one-eighth that of other spray
methods.
Conventional plasma: Conventional plasma spraying provides free-plasma
temperatures in the powder heating region of 5500° C. (10,000° F.)
with argon plasma, and 4400° C. (8000° F.) with nitrogen plasma -
above the melting point of any known material. To generate the plasma,
an inert gas is superheated by passing it through a [symbol] arc.
Powder feedstock is introduced and is carried to the
workpiece by the plasma stream. Provisions for cooling or
regulation of the spray [symbol] e may be required to maintain substrate
temperatures in the 95 to 205° C. (200 to 400° F.) range.
Typical spray rate is 0.1 kg/h/kW (0.2 lb/h/kW)
Detonation gun: Suspended powder is fed into a 1 [symbol] (3 ft) long tube
along with oxygen and fuel gas. A spark ignites the mixture and
produces a controlled explosion. The high temperatures and pressures
(1 MPa, 350 psi) that are generated blast the particles out of the
end of the tube toward the substrate.
High-Velocity OxyFuel: In HVOF spraying, a fuel gas and oxygen are
used to create a combustion flame at 2500 to 3100° C. (4500 to
5600° F.). The combustion takes place at very high chamber
pressure (150 psi), exiting through a small-diameter barrel to
produce a supersonic gas stream and very high particle
velocities. The process results in extremely dense, well-bonded
coatings making it attractive for many corrosion-resistant applica-
tions. Either powder or wire feedstock can be sprayed, at typical
rates of 2.3 to 14 kg/h (5 to 30 lb/h).
High-energy plasma: The high-energy plasma process provides signifi-
cantly higher gas [symbol] and temperatures especially in the powder
heating region, due to a [symbol] stable, longer arc and higher power
density in the [symbol] nozzle. The added power (two to three times that
of conventional plasma) and gas flow (twice as high) provide larger,
higher temperature powder injection region and reduced air [symbol] rainment.
All this leads to improved powder melting, few unmelts, and high
particle impact velosity.
Vacuum plasma: Vacuum plasma uses a conventional plasma torch in a
chamber at pressures in the range of 10 to 15 kPa (0.1 to 0.5 [symbol] )
At low pressures the plasma is larger in diameter, longer, and has
a higher velocity. The absence of oxygen and the ability to operate
with higher substrate temperatures produces denser, more [symbol] coatings
having much lower oxide contents.

### BRIEF SUMMARY OF THE INVENTION

A process, apparatus and material composition for forming a coherent refractory mass on a surface wherein one or more non-combustible materials are mixed with one or more metallic combustible powders and an oxidizer, igniting the mixture in a combustion chamber so that the combustible metallic particles react in an exothermic manner with the oxidizer and release sufficient heat to form a coherent mass of the material under the action of the heat of combustion, and projecting this mass against the surface so that the mass adheres durably to the surface.

The combustion chamber can be embodied to have a reverse vortex flow of gas in the chamber which is effective to insulate the walls of the chamber from the high temperature of combustion.

### BRIEF DESCRIPTION OF THE SEVERAL VIEWS OF THE DRAWINGS

The invention will be further described in the following detailed description taken in conjunction with the accompanying drawings in which:

FIG. 1 is a diagrammatic representation of apparatus in accordance with one aspect of the invention;

FIG. 2 is a diagrammatic representation of apparatus in accordance with a second aspect of the invention;

FIG. 3 illustrates one form of the combustion chamber in the shape of a frustum;

FIG. 4 is a cross-sectional view of one embodiment of a reverse vortex generator;

FIG. 5 is a diagrammatic representation of a cylindrical combustion chamber according to the invention;

FIG. 6 is a diagrammatic representation of another embodiment of a combustion chamber according to the invention;

FIG. 7 shows a variation of the combustion chamber of FIG. 6;

FIG. 8 shows a further embodiment of a combustion chamber having inner and outer vessels;

FIG. 9 is a cross-sectional view of the chamber of FIG. 8; and

FIG. 10 is a diagrammatic illustration of a screen conveyer apparatus according to the invention.

### DETAILED DESCRIPTION OF THE INVENTION

The present patent is very similar to co-pending patent application Ser. No. 10/774,199 by the same applicant as herein. However, the co-pending patent application is primarily directed to the process of “painting” lines on highways whereas the present application is more generally applicable to flame spraying high temperature ceramic materials onto any surface without the use of external sources of energy.

The typical non-combustible materials used in the present application are powdered metal oxides such as titanium dioxide, aluminum oxide, silicon dioxide, chromium oxide, magnesium oxide, iron oxide, zirconium oxide, zinc oxide or a mixture of two or more thereof. All of these materials have melting temperatures above the typical oxygen fuel flame temperature and all of them are non-electrically conducting.

The source of heat is a powdered metallic fuel which is mixed with the powdered non-combustible materials that are to be flame sprayed. The non-combustible materials, metallic fuel and oxygen are mixed in a combustion chamber, ignited, and propelled from the end of the combustion chamber to impinge on the surface to be coated. The heat of combustion is sufficient to melt or soften the non-combustible materials and cause them to adhere to the surface to be coated.

Typically the powdered metallic fuel is mixed with the powdered non-combustible materials before entering the combustion chamber. However, in some cases it may be beneficial to mix the powdered fuel with the non-combustible material only after the materials have entered the combustion chamber.

The typical metallic fuel is selected from a group consisting of aluminum, silicon, zinc, magnesium, zirconium, iron and chromium or a mixture or two or more thereof. The flame temperature of these fuels are sufficiently high so that even Tungsten (melting point of 3695 Degrees Kelvin) could be flame sprayed with the technique shown in this patent.

The temperature can be controlled by the mixture and type of powdered fuel and the fuel/oxygen/air ratio. For example, to flame spray aluminum, chromium, or titanium oxides, the fuel would be aluminum powder which can generate a flame temperature in excess of 4,000° C. (7200° F.) which is sufficient to melt all of the oxides listed above.

If the objective is to flame spray silicon dioxide, then the fuel can be pure silicon powder along with air and/or a mixture of air and oxygen. The actual temperature can be controlled by varying the amount of excess air or the amount of silicon dioxide versus the silicon powder. The flame temperature of silicon can exceed 3100° C. (5600° F.).

For example, it is relatively easy to spray aluminum oxide or titanium dioxide directly onto steel in order to provide a long lasting, acid resistant, corrosion resistant, salt water resistant coating. This process can be performed in line with the actual iron or steel fabrication process or can be applied in the field. Since the source of energy to melt the ceramic materials is typically less than 10% of the weight of the ceramic materials, there is little weight and size penalty to perform the flame spraying process in the field.

The process can also be used to flame spray heat resistant refractory materials onto a roof to control the thermal properties of the roofing material. For example, aluminum and titanium oxides are almost perfectly white and reflect and scatter over 99% of the light (and heat) which impinges upon the surface.

On the other extreme, one form of iron oxide is black and can be flame sprayed onto a roof surface to enhance the energy absorption of the surface.

The process can be performed in situ where necessary and can always be performed in the factory where the roofing materials are prepared or a separate facility.

Another application is protecting the steel and iron pipes uses in the coal-tar gasoline extraction industry. In this case the pipes used to extract the tar are attacked by acid and have to be replaced frequently. By coating the surface of the pipes with silicon dioxide, the pipes would be protected from corrosion by the acid. The composition of the ceramic materials used to coat the pipes can be tailored to match the thermal expansion characteristics of the pipes.

Another application is to use melted silicon dioxide (glass) as a “glue” to bind a higher temperature refractory material to a surface. For example, silicon powder could be the fuel along with air as the oxygen source. The silicon would burn to produce silicon dioxide. The flame temperature can be controlled by the addition of excess air so that the flame temperature is sufficient to melt additional silicon dioxide but not some other ceramic material contained in the powder composition. The silicon dioxide would act as “glue” to bind the other ceramic materials onto the surface.

The present invention addresses the problem experienced by conventional thermal spraying processes in which oxidation reactions occur on the surface of powder particles prior to impact on the surface being coated, by limiting the chemicals which will be “thermally sprayed” to those which are already in oxide form; such as titanium dioxide and silicon dioxide.

The process, equipment and chemicals described in the above-noted copending patent application of the same applicant as the present invention uses a chemical burning process to flame spray refractory material into a road or other surface that can withstand the temperature involved. This type of flame spraying process can deposit anywhere from 10 Kg to 500 Kg per hour onto a surface as compared to the traditional flame spray process, which can typically only deposit up to 12 Kg per hour.

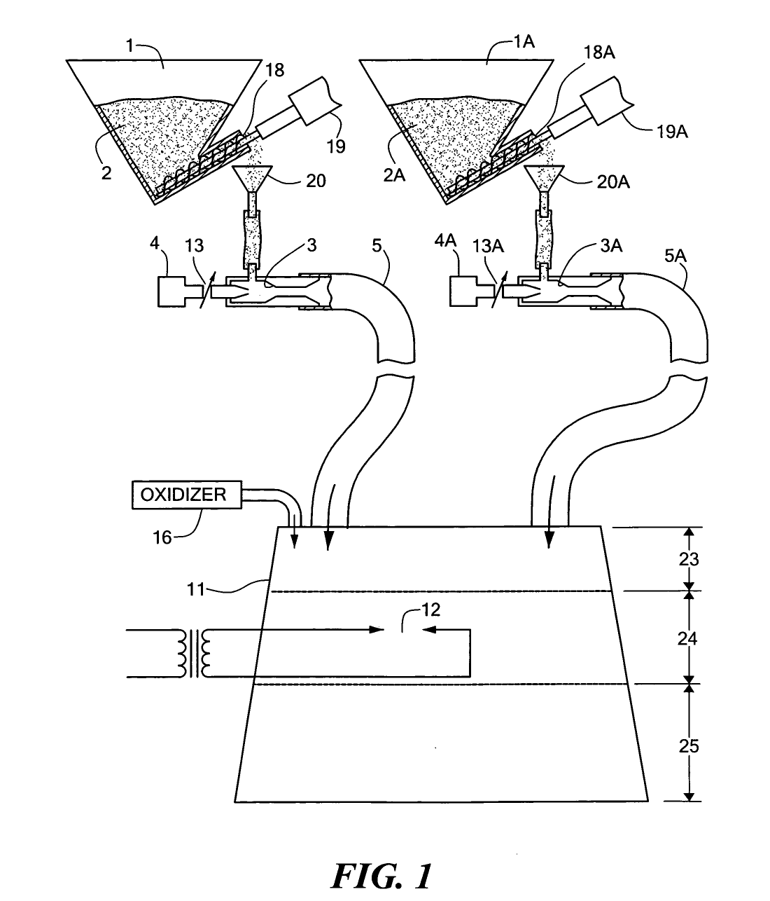

Apparatus according to one aspect of the invention is shown diagrammatically in FIG. 1. Metallic combustible powder is contained in a hopper or other container (1). Non-combustible oxide powder is contained in a hopper or other container (1A). These materials are conveyed such as by screw conveyers (18) and (18A) (or other suitable conveying mechanism) to an aspirating device (3) and (3A) where a gas carrier (typically air, oxygen or a mixture of the two)supplied by source (4) carries via supply lines (5) and (5A) the powder to the mixing chamber (23), which also receives an oxidizer from an oxidizer source (16). The gas carrier can be adjusted by a control valve (13) and (13A). The mixed components are conveyed to a combustion chamber (24) which has a igniter (12) associated therewith to ignite the mixture provided to the combustion chamber. The combustion chamber has an outlet (25) from which emanates the flame spray for propulsion onto the surface being coated. The oxidizer is typically air, pure oxygen or a mixture of the two. In the embodiment of FIG. 1 the combustible powder and the non-combustible powders are supplied to the mixer via respective supply lines.

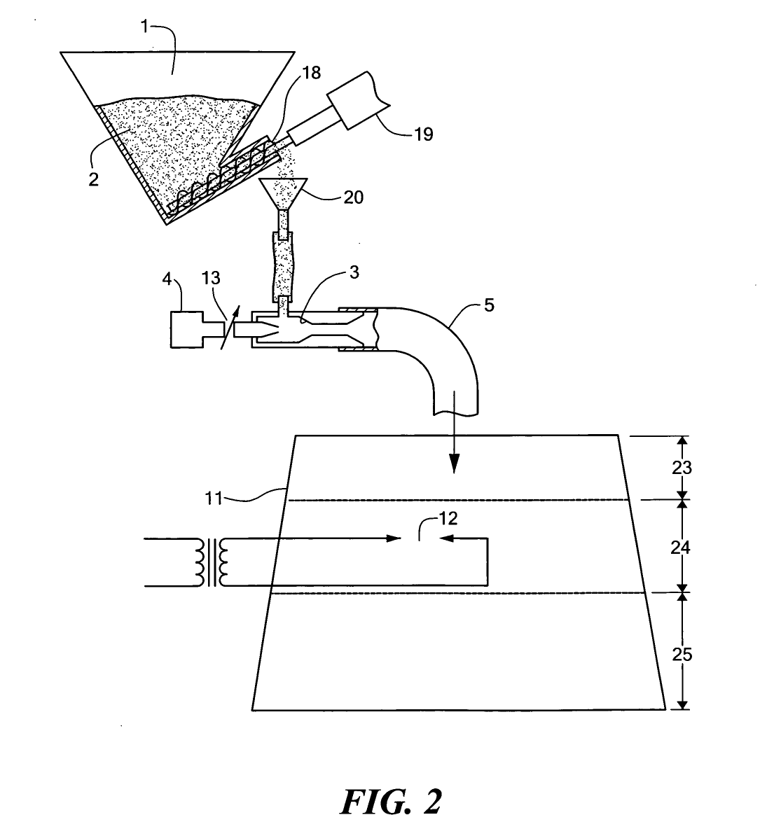

FIG. 2 is an alternative embodiment, wherein the combustible and non-combustible powders can be supplied from a single container (1) and provided by a single supply line (5) to the mixer. The oxidizer, supplied by source (4), can simultaneously act as the carrier and the oxidizer and be supplied along the same supply line as the combustible and non-combustible powders.

In FIGS. 1 and 2 the conveyer is driven by a variable speed motor (19) or (19A) to provide the intended volume of material to the combustion chamber or mixer.

The combustion chamber can have a nozzle outlet for projecting the refractory mass onto the surface being coated. The combustion chamber may have, for particular applications, an outlet sized and shaped to accommodate the particular work surface being coated.

Because of the very high temperatures involved in the flame spray operation, typically 3000 degrees C. and higher, it is very important to insulate the walls of the combustion chamber from the combustion process inside of the combustion chamber. One very effective method of doing this is to create a “reverse vortex” air flow inside of the combustion chamber.

FIG. 3 illustrates one form of a reverse vortex combustion chamber. The combustion chamber is shaped as a frustum, which is a cone cut off at the narrow end. The narrow portion of the frustum (27) is the entrance or closed end of the combustion chamber and the wider portion (28) is the exit or open end of the combustion chamber. An exit aperture is typically provided at the open end and from which the flame spray is emitted. The powdered fuel/ceramic mixture is injected at (26) into the closed end of the combustion chamber as shown, and along the axis (29) of the chamber. The igniter (29) can be positioned on the side of the combustion chamber or along the same axis (29) as the fuel injection point. The gas carrier (typically air) of the powdered mixture causes an axial flow from the closed end to the open end of the combustion chamber. As an alternative, a portion of the powdered fuel/ceramic mixture can be introduced into the chamber along with air injected for the reverse vortex, such as at points (30).

Air is injected tangentially at one or more points (30) near the open end of the combustion chamber. This produces a gas flow (31) tangential to the walls of the frustum. The air flows relatively slowly from the open end to the closed end of the combustion chamber. Since the tangential air flow travels from the open end to the closed end of the combustion chamber, it is called a “reverse” vortex. It has been shown that a reverse vortex acts as an extremely good thermal insulator preventing the high temperature combustion along the axis of the combustion chamber from melting the walls of the combustion chamber, (See “Thermal Insulation of Plasma in Reverse Vortex Flow” by Dr. A. Gutsol, Institute of Chemistry and Technology, Kola Science Centre of the Russian Academy of Sciences) (Also see published application WO 2005/004556). Optionally, a second tangential gas flow may be introduced at one or more points (32) near the closed end of the combustion chamber. The tangential gas flow is directed so that the direction of rotation about the axis of the combustion chamber is in the same direction (33) as that produced by the air injected at point(s) (30). This second tangential gas injector promotes a faster reverse vortex and promotes better mixing of the fuel/air mixture.

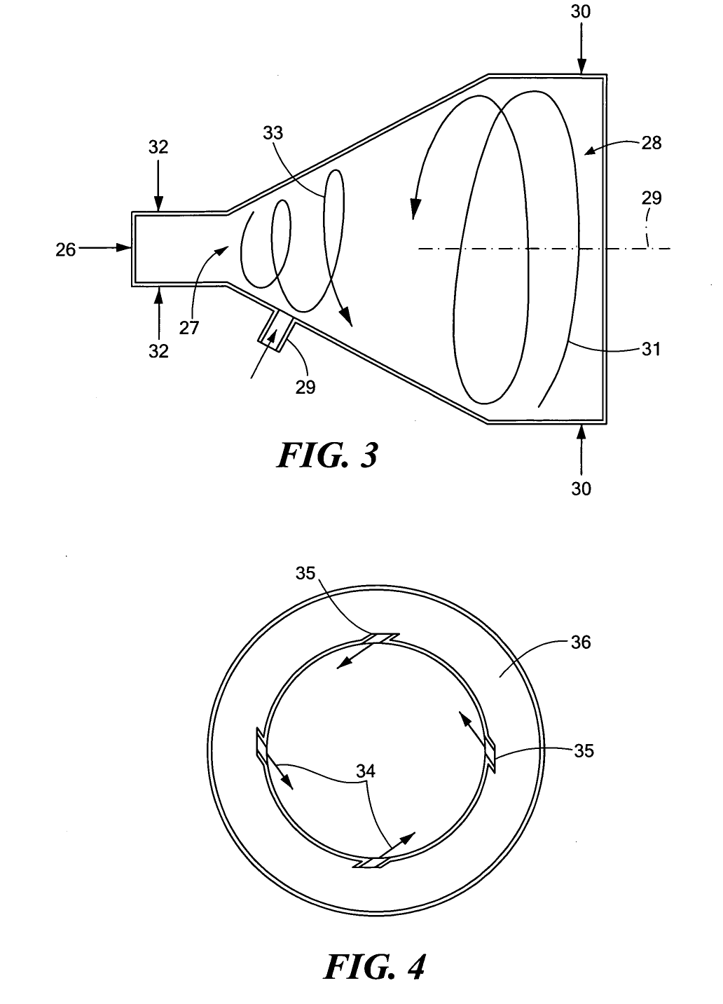

FIG. 4 depicts a cross-sectional view of a multiple nozzle arrangement, wherein gas enters the combustion chamber tangentially at (34) through four nozzles (35) coupled to a plenum (36), thereby creating a gas flow tangential to the wall of the exit of the combustion chamber. This creates a vortex gas flow which gradually moves from the open end to the closed end of the combustion chamber with a strong circumferential velocity component.

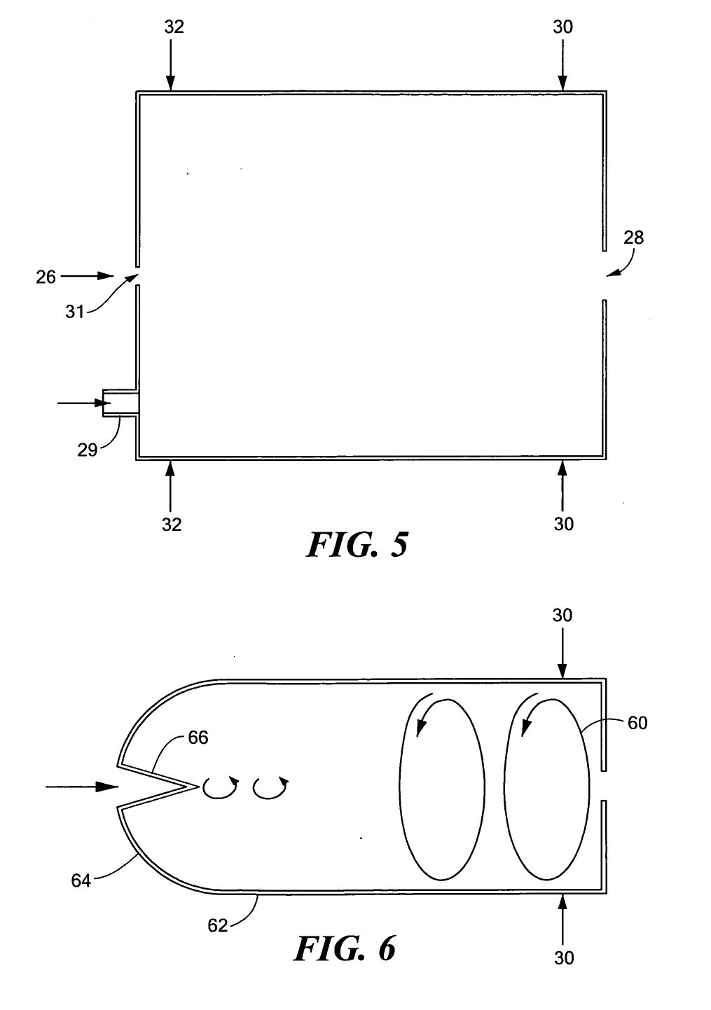

FIG. 5 illustrates another form of the combustion chamber in the shape of a cylinder. As before, the powdered fuel/air mixture (26) is injected into the chamber at the closed end (31) along the axis of the cylinder. Air is injected tangentially at point(s) (30) and/or (32) to create a reverse vortex flow from the open end (28) to the closed end (31) of the combustion chamber. The exit from the chamber may have a restricted aperture or a specially shaped nozzle.

The frustum shown in FIG. 3 can be configured to improve the operation of the combustion chamber. For example, the powdered fuel/ceramic powder mixture can be injected directly into the reverse vortex port at points (30) in the combustion chamber, thereby causing improved mixing of the air with the powder. In addition, the powdered fuel mixture will absorb radiant heat from the center of the combustion chamber thereby preheating the powdered mixture while at the same time insulating the combustion chamber walls from the heat of combustion.

If the selected fuel is silicon powder, there is an added benefit. Silicon powder is black as coal dust and acts as a perfect “black body” absorber. This will significantly improve the preheating of the fuel/air mixture and cool the walls of the combustion chamber.

If the powdered fuel mixture is injected into the reverse vortex port, then the igniter can be centered on the axis of the chamber at the closed end. Likewise, the same approach can be taken with the cylindrical combustion chamber shown in FIG. 5. In this case the powdered fuel mixture is injected into the reverse vortex port at points (30) along with the air flow to support combustion and cool the walls of the combustion chamber. In this case the igniter (29) can be placed at the center of the closed end of the combustion chamber.

FIG. 6 illustrates another important aspect of the invention, illustrated with a cylindrical combustion chamber (62)having a curved end (64) and, optionally, an inwardly extending conical portion (66). The reverse vortex air stream is illustrated as (60) and is produced by air or oxygen injected at points (30) as described. This air steam flows along the inside walls of the combustion chamber (62) with an initial rotational angular velocity. When the air stream approaches the closed end (64) of the combustion chamber, the diameter of the chamber is reduced according to the specific shape of the closed end. The velocity of the reverse vortex air stream remains basically constant and therefore the angular velocity of the air stream increases as the diameter of the chamber decreases.

The shape of the closed end also causes the vortex stream to reverse direction and travel to the open end of the chamber and in the axial center of the combustion chamber. The higher angular velocity caused by the shape of the closed end of the combustion chamber improves the mixing of the fuel/air/powder thereby improving combustion and heat transfer to the non-combustible powder. In addition, the angular rotation of the air stream increases the effective length of the combustion chamber and thus increases the dwell or residence time of the combustion chamber. The shape of the closed end of the combustion chamber can be designed to “focus” the reverse vortex spiral as it travels from the closed end to the open end of the combustion chamber. The fuel/powder mixture can be introduced at points (30) and/or at other ports into the chamber, as described above.

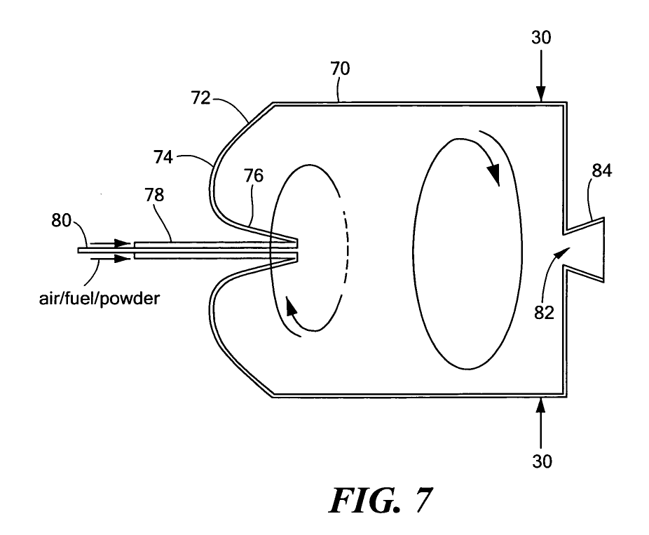

Another embodiment of a combustion chamber in accordance with the invention is shown in FIG. 7. The chamber (70) is of cylindrical shape having a conical section (72) end and a curved transitional section (74) which joins an optional inwardly extending conical portion (76). A pair of concentric pipes (78) and (80) are positioned at the closed end of the annular area of portion (76). The inner pipe (80) is part of the plasma igniter. The outer pipe (78) serves to inject air and the fuel/ceramic powder mixture into the combustion chamber. A small amount of fuel/ceramic powder may be introduced with a larger volume of air into the chamber at points (30), as in the above embodiment. The exit end of the combustion chamber has an aperture (82)which is in communication with a nozzle (84) for providing the plasma spray to a work surface. The nozzle may not be necessary for all applications. For applications not requiring a nozzle, the plasma spray emanates from the aperture (82) of the chamber.

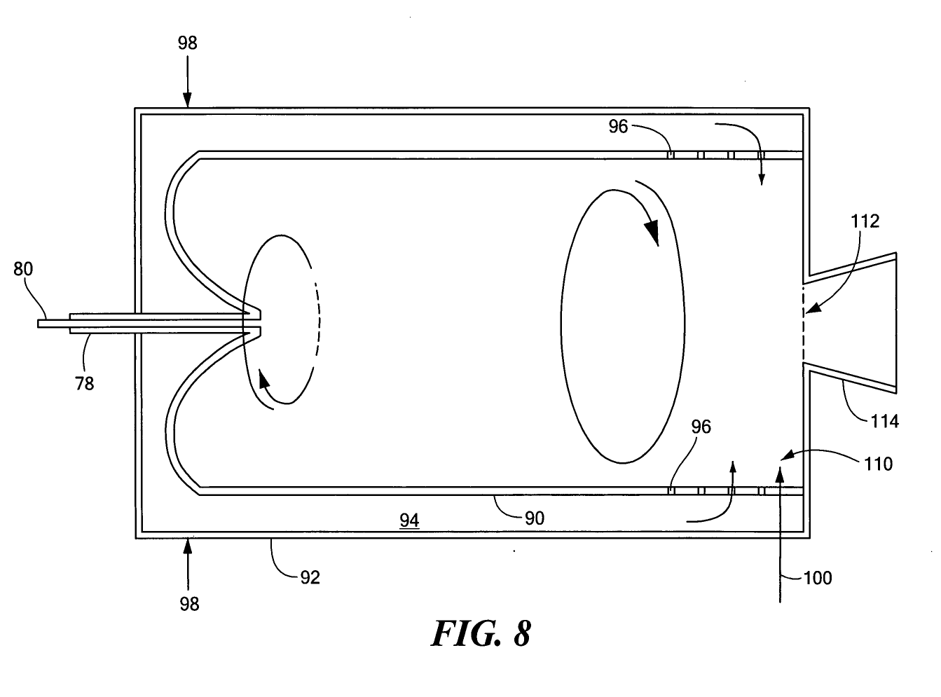

A further embodiment of a combustion chamber is shown in FIG. 8. The combustor has a cylindrically shaped ceramic inner lining (90) that has a closed end of curved configuration which terminates in an optional inwardly extending conical portion similar to that shown in FIG. 7. This closed end is shaped to change the direction of the reverse vortex. Alternatively, the closed end of the chamber may be flat. The chamber (90) is enclosed within an outer housing (92) which is typically made of steel or titanium. The space (94) between the inner ceramic chamber and outer housing is in fluid communication with the inside of the combustion chamber by means of holes or openings (96) provided through the wall of the combustion chamber near the open or exit end thereof. The openings are preferably oriented tangentially to the inside surface of the combustion chamber and directed toward the closed end of the chamber. The openings are oriented at a tangential angle of approximately 20°.

In one version of a combustion chamber shown in FIG. 8 two concentric pipes (78) and (80) are located at the closed end of the double-walled combustion chamber. As discussed in FIG. 7, the inner pipe (80) is normally configured as a high temperature plasma igniter and the larger pipe (78) serves as the entry port for the powdered fuel/ceramic powder and air/oxygen mixture. As discussed below, the igniter and entry ports can be otherwise located.

In one form of the combustion chamber the powdered fuel/air mixture is injected at one or more points (98) into the space (94) between the inner and outer housings. The air is injected tangentially to the inside wall of the outer housing (92) and results in a forward vortex of air/fuel which spirals in space (94) toward the open end of the combustor. The forward vortex cools the surface of the inner ceramic shell and thermally insulates the outer shell from the inner shell and preheats the air/fuel mixture prior to the mixture being injected into the combustion chamber at openings (96). Since the space (94) is sealed, pressure builds up in this space and forces the air/fuel mixture through the openings (96) and into the combustion chamber. The orientation of the openings causes a reverse vortex to be formed on the inside of the combustion chamber which flows in a spiral manner from the open end towards the closed end of the chamber.

A plasma igniter (100) extends through the outer housing and wall of the inner vessel into the exit portion of the combustion chamber, as illustrated. The igniter directs its ignition plasma tangentially to the wall of the combustion chamber and pointed slightly toward the closed end of the chamber. The igniter causes the fuel/air mixture to ignite approximately at point (110) and the flame to propagate in a reverse vortex manner toward the closed end of the combustion chamber. As described above, the closed end of the combustion chamber is preferably shaped to reverse the direction of the burning reverse vortex and increase the tangential velocity of the resulting vortex which propagates forwardly toward the open end of the chamber.

The result of the fuel/air mixture burning during the traversal of the reverse vortex in the chamber and the continued burning of the mixture in the forward propagation of the vortex increases the time that burning occurs inside the combustion chamber. This residence time is an important factor in causing the fuel to burn completely and to transfer the maximum amount of heat energy to the non-combustible ceramic powders mixed with the combustible metallic powders. The exit aperture (112) of the combustion chamber may be significantly smaller than the inside diameter of the chamber. This choked chamber serves to increase the residence time of the burning mixture in the combustion chamber, to increase the pressure in the combustion chamber and to increase the velocity of the exhaust from the combustion chamber. The exhaust speed of the molten ceramic particles is very important in achieving the intended adhesion of the particles on the surface to be coated. Optionally, an exhaust nozzle (114) may be attached to the output of the combustion chamber.

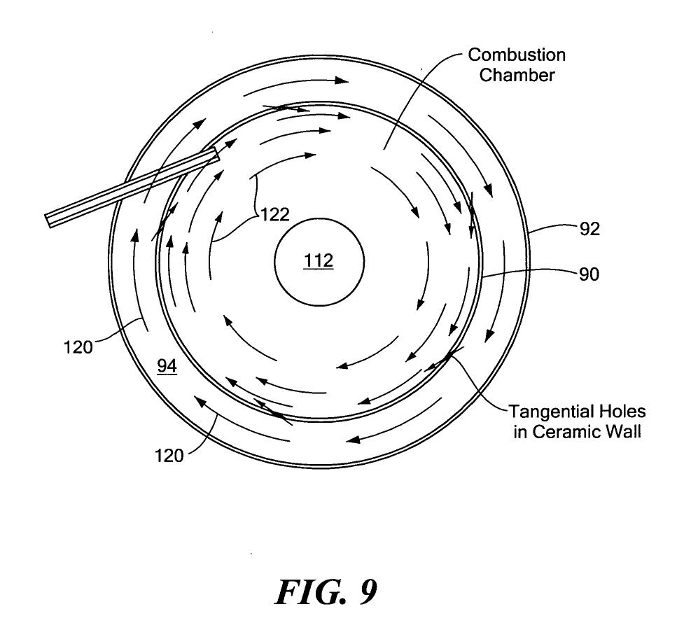

FIG. 9 illustrates a cross-sectional view of the embodiment of FIG. 8. Arrows (120) illustrate the rotational and spiral flow of the air/fuel mixture in the space (94) toward the open end of the combustion chamber. As the only exit from the space (94) is through openings (96) in the combustion chamber wall, the fuel/air mixture is forced through these openings in a tangential manner and onto the inner surface of the combustion chamber. The reverse vortex formed inside the chamber is ignited by the plasma igniter as described above and results in a burning reverse vortex flame propagation pattern illustrated by arrows (122).

In another form of the combustion chamber only a portion of the powdered fuel/air mixture is injected at one or more points (98) into the space (94) between the inner and outer housings. The powdered fuel-air mixture is configured to be a lean mixture which is not sufficient to maintain combustion. This mixture is injected tangentially to the inside wall of the outer housing (92) and results in a forward vortex of air/fuel which spirals in space (94) toward the open end of the combustor. The forward vortex cools the surface of the inner ceramic shell and thermally insulates the outer shell from the inner shell and preheats the air/fuel mixture prior to the mixture being injected into the combustion chamber at openings (96). Since the space (94) is sealed, pressure builds up in this space and forces the air/fuel mixture through the openings (96) and into the combustion chamber. The orientation of the openings causes a reverse vortex to be formed on the inside of the combustion chamber which flows in a spiral manner from the open end towards the closed end of the chamber.

In this case the igniter is typically placed on the central axis of the combustion chamber and at the closed end as indicated by the pipe (80). The majority of the powdered fuel/ceramic powder air/oxygen mixture is projected into the combustion chamber via pipe (78) located at the closed end of the combustion chamber. When mixed with the lean mixture from the reverse vortex the resulting fuel/air mixture now sustains combustion.

Typically, the combustion chamber is formed as a molded or machined ceramic vessel, which can be a single replaceable unit. A typical ceramic material is aluminum oxide which has a melting point of 3762° F. Since the typical combustible metallic fuel is silicon and the typical non-combustible material is silicon dioxide, the combustion chamber is designed to operate at a temperature of about 2750° F. which is the melting temperature of silicon dioxide.

The outer housing is typically made from steel or titanium and this housing is isolated from the extreme temperatures on the inside of the ceramic combustion chamber by the forward vortex of air and powdered fuel which is caused to flow between the inner and outer shells.

In the embodiments of the combustion chamber described herein, it will be appreciated that air or oxygen can be introduced into the chamber at one or more different positions, and that fuel and/or powder can also be introduced into the chamber at one or more positions, separate from or together with the air/oxygen. The igniter can also be variously located to ignite the mixture in the chamber.

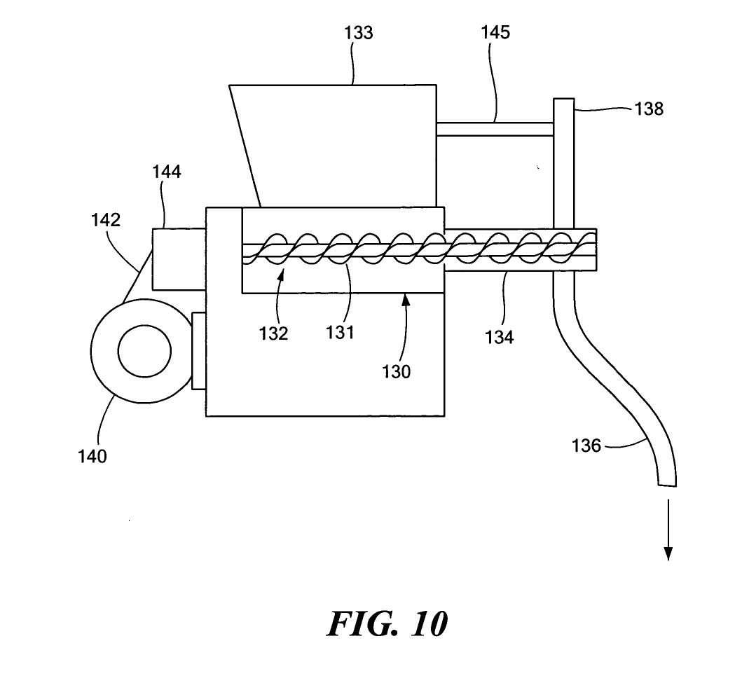

FIG. 10 shows a powder feeder. The feeder includes a screw conveyer (130) having a trough (131) and screw feeder (132) which conveys the combustible and non-combustible powders contained in a hopper (133) or other container through a feeder tube (134) to a pipe or hose (136) which serves as a supply line to the combustion chamber. The pipe or hose (136) may be flexible or rigid depending on the particular installation. Air or oxygen is injected into tube (138) for mixing with the fuel/ceramic powder provided by the screw conveyer. Tube (138) may be in fluid communication with the hopper (133) via tube (145). In this case the hopper (133) will have be sealed from the normal atmospheric pressure by a cover. The tube (145) serves to equalize the pressure at both ends of the screw feeder (132) and prevent the powder from being driven backward through the feeder tube (134) to the hopper (133). The ratio of air/oxygen to the fuel/ceramic powder can be independently controlled to provide precise mixing of an intended amount of air/oxygen and fuel/powder. An electric motor (140) drives the screw conveyer via a pulley and belt assembly (142) and speed reducer (144). Other motive means can be utilized in alternative implementations.

The invention is not to be limited by what has been particularly shown and described and is to embrace the full spirit and scope of the appended claims.

What is claimed is:

1. Apparatus for forming a coherent refractory mass on a surface, the apparatus comprising:
a combustion chamber adapted to be disposed on a surface;
a container for holding metallic combustible powder(s) and non-combustible ceramic powder(s);
a first supply line for transporting one or more metallic combustible powders, one or more non-combustible powders and an oxidizer to the combustion chamber;
a second supply line for supplying air to the combustion chamber to supply additional oxygen, to assist in projecting the refractory mass from the combustion chamber and for cooling the inside of the combustion chamber; and
an igniter associated with the combustion chamber and operative to ignite the combustible powder, non-combustible material and oxidizer in the combustion chamber to cause the metallic combustible powder to react in an exothermic manner with the oxygen and release sufficient heat to form a refractory mass which is projected against the surface so that the mass adheres durable to the surface.

2. The apparatus of claim 1 wherein the first supply line includes a gas carrier for transporting the combustible and ceramic powder from the container to the combustion chamber.

3. The apparatus of claim 1 wherein the igniter is an electric arc.

4. The apparatus of claim 1 wherein the igniter is a gas pilot light.

5. The apparatus of claim 1 wherein the igniter is a plasma arc.

6. The apparatus of claim 2 wherein the gas carrier is air, oxygen or a combination of the two.

7. The apparatus of claim 1 wherein the rate of deposition of the coherent mass onto the surface is controlled by the rate of movement between the surface and the exit of the combustion chamber or vice-versa.

8. The apparatus of claim 1 wherein the combustion chamber is made of a ceramic material.

9. The apparatus of claim 1 wherein the combustion chamber contains openings into which a gas is injected to prevent the combustion products from contacting the inside surface of the combustion chamber and binding thereto.

10. The apparatus of claim 9 wherein the gas is air.

11. The apparatus of claim 1 wherein the combustion chamber is made of metal that is coated on the inside with a high temperature ceramic coating.

12. The apparatus of claim 1 wherein the second supply line causes a reverse vortex to form inside the combustion chamber in order to insulate the walls of the combustion chamber from the heat of combustion.

13. The apparatus of claim 12 wherein the chamber is substantially frustum-shaped.

14. The apparatus of claim 12 wherein the chamber is substantially a cylinder.

15. The apparatus of claim 13 wherein the combustion chamber has a closed end and an open end, and wherein the first supply line injects one or more metallic combustible powders, one or more non-combustible materials and an oxidizer into the closed end of the combustion chamber and substantially along the axis of the frustum.

16. The apparatus of claim 14 wherein the combustion chamber has a closed end and an open end, and wherein the first supply line injects one or more metallic combustible powders, one or more non-combustible materials and an oxidizer into the closed end of the cylinder and substantially along the axis of the cylinder.

17. The apparatus of claim 12 wherein the apparatus for creating a reverse vortex consists of a gas flow which flows circumferentially along the inside surface of the combustion chamber and travels from the open end to the closed end of the combustion chamber.

18. The apparatus of claim 12 wherein the apparatus for creating circumferential gas flow comprises a gas supply and one or more gas inlet nozzles oriented tangentially relative to the inside wall of the combustion chamber.

19. The apparatus of claim 18 wherein the gas inlet nozzles are located approximately at the open end of the combustion chamber.

20. The apparatus of claim 18 wherein the gas inlet nozzles are located approximately at the closed end of the combustion chamber.

21. The apparatus of claim 18 wherein the gas inlet nozzles are located at both the open and closed portions of the combustion chamber.

22. The apparatus of claim 1 wherein the igniter is located off of the center axis of the combustion chamber.

23. The apparatus of claim 1 wherein the igniter is located on the center axis of the combustion chamber.

24. The apparatus of claim 17 wherein said circumferential flow generates an axially-symmetric circumferential fluid flow.

25. The apparatus of claim 1 where the first supply line injects one or more metallic combustible powders, one or more non-combustible materials and an oxidizer into a reverse vortex port at the open end of the combustion chamber.

26. The apparatus of claim 1 where the second supply line injects one or more metallic combustible powders, one or more non-combustible materials and an oxidizer into a reverse vortex port at the open end of the combustion chamber.

27. The apparatus of claim 25 wherein the oxidizer is either air or oxygen.

28. The apparatus of claim 26 wherein the oxidizer is either air or oxygen.

29. The apparatus of claim 13 wherein the combustion chamber has a closed end which is shaped so as to increase the angular velocity of the air stream as it changes direction from a reverse vortex to a direct vortex from the closed end to an open end of the combustion chamber.

30. The apparatus of claim 14 wherein the combustion chamber has a closed end which is shaped so as to increase the angular velocity of the air stream as it changes direction from a reverse vortex to a direct vortex from the closed end to an open end of the combustion chamber.

31. The apparatus of claim 1 wherein the container is a volumetric screw feeder used for the metering of dry solids into a process.

32. The apparatus of claim 1 wherein the rate of delivery of the combustible and non-combustible powder is controlled by a screw conveyor driven by a variable speed motor.

33. The apparatus of claim 1 wherein the rate of delivery of the combustible and non-combustible powder is controlled by means of a variable valve which controls a gas carrier.

34. The apparatus of claim 33 wherein the gas carrier is air, oxygen or a combination of the two.

35. The apparatus of claim 31 wherein the output of the screw feeder is in fluid communication with the container holding the combustible and non-combustible powders.

36. The apparatus of claim 31 wherein the container holding the combustible and non-combustible powders is sealed from atmospheric pressure.

37. The apparatus of claim 1 wherein the combustion chamber is cylindrical in shape, is formed from two concentric shells with the space between the shells fully enclosed and in fluid communication with the interior portion of the combustion chamber.

38. The apparatus of claim 37 wherein one end of the combustion chamber is closed to prohibit the exhaust of the combustion products and one end is open to permit the exhaust of the combustion products.

39. The combustion chamber of claim 38 wherein the second supply line injects one or more metallic combustible powders, one or more non-combustible materials and an oxidizer into the space between the inner and outer shells of the combustion chamber to causes a forward vortex to form in the space between the inner and outer shells of the combustion chamber wherein the vortex travels in the direction from the closed end to the open end of the combustion chamber.

40. The apparatus of claim 39 wherein the forward vortex is in fluid communication with the central portion of the combustion chamber and causes a reverse vortex to flow circumferentially along the inside surface of the central portion of the combustion chamber and to travel in the direction from the open end to the closed end of the combustion chamber.

41. The apparatus of claim 38 wherein the second supply line injects air, oxygen or a combination of both into the space between the inner and outer shells of the combustion chamber to causes a forward vortex to form in the space between the inner and outer shells of the combustion chamber wherein the vortex travels in the direction from the closed end to the open end of the combustion chamber.

42. The apparatus of claim 41 wherein the forward vortex is in fluid communication with the central portion of the combustion chamber and causes a reverse vortex to flow circumferentially along the inside surface of the central portion of the combustion chamber and to travel in the direction from the open end to the closed end of the combustion chamber.

43. The apparatus of claim 38 wherein the first supply line injects one or more metallic combustible powders, one or more non-combustible materials and an oxidizer into the closed end of the combustion chamber.

44. The apparatus of claim 38 wherein the igniter is located on the central axis of the combustion chamber and at the closed end.

45. The apparatus of claim 38 wherein the flame from the igniter is directed tangential to the surface of the inner wall of the central portion of the combustion chamber and in proximity to the open end of the combustion chamber.

46. Apparatus for forming a coherent refractory mass on a surface, the apparatus comprising:
a combustion chamber adapted to be disposed on a surface;
a container for holding metallic combustible powder(s) and non-combustible ceramic powder(2);
a single supply line for transporting one or more metallic combustible powders, one or more non-combustible powders and an oxidizer to the combustion chamber; and
an igniter associated with the combustion chamber and operative to ignite the combustible powder, non-combustible powder and oxidizer in the combustion chamber to cause the metallic combustible powder to react in an exothermic manner with the oxidizer and release sufficient heat to form a refractory mass which is projected against the surface so that the mass adheres durable to the surface.

47. The apparatus of claim 46 wherein one end of the combustion chamber is closed to prohibit the exhaust of the combustion products and one end is open to enable the exhaust of the combustion products.

48. The apparatus of claim 46 wherein the igniter is an electric arc.

49. The apparatus of claim 46 wherein the igniter is a gas pilot light.

50. The apparatus of claim 46 wherein the igniter is a plasma arc.

51. The apparatus of claim 46 wherein the rate of delivery of the combustible and non-combustible powder(s) is controlled by a screw conveyor driven by a variable speed motor and a variable valve which controls the rate of delivery of air, oxygen or a combination of the two.

52. The apparatus of claim 46 wherein the rate of deposition of the coherent mass onto the surface is controlled by the rate of movement between the surface and the exit of the combustion chamber or vice-versa.

53. The apparatus of claim 46 wherein the combustion chamber is made of a ceramic material.

54. The apparatus of claim 46 wherein the combustion chamber is made of metal that is coated on the inside with a high temperature ceramic coating.

55. The apparatus of claim 46 wherein the supply line causes a reverse vortex to form inside the combustion chamber in order to insulate the walls of the combustion chamber from the heat of combustion.

56. The apparatus of claim 46 wherein the chamber is substantially a cylinder.

57. The apparatus of claim 47 wherein the supply line injects one or more metallic combustible powders, one or more non-combustible materials and an oxidizer into the closed end of the combustion chamber and substantially along the axis of the chamber.

58. The apparatus of claim 55 wherein the apparatus for creating a reverse vortex consists of a gas flow which flows circumferentially along the inside surface of the combustion chamber and travels from the open end to the closed end of the combustion chamber.

59. The apparatus of claim 55 wherein the apparatus for creating circumferential gas flow comprises a gas supply and one or more gas inlet nozzles oriented tangentially relative to the inside wall of the combustion chamber.

60. The apparatus of claim 59 wherein the gas inlet nozzles are located approximately at the open end of the combustion chamber.

61. The apparatus of claim 59 wherein the gas inlet nozzles are located approximately at the closed end of the combustion chamber.

62. The apparatus of claim 59 wherein the gas inlet nozzles are located at both the open and closed portions of the combustion chamber.

63. The apparatus of claim 46 wherein the igniter is located off of the center axis of the combustion chamber.

64. The apparatus of claim 46 wherein the igniter is located on the center axis of the combustion chamber.

65. The apparatus of claim 59 wherein said circumferential flow generates an axially-symmetric circumferential fluid flow.

66. The apparatus of claim 47 where the supply line injects one or more metallic combustible powders, one or more non-combustible materials and an oxidizer into a reverse vortex port at the open end of the combustion chamber and causes a reverse vortex to form inside the combustion chamber.

67. The apparatus of claim 47 wherein the closed end of the combustion chamber is shaped so as to increase the angular velocity of the air stream as it changes direction from a reverse vortex to a direct vortex from the closed end to the open end of the combustion chamber.

68. The apparatus of claim 46 wherein the container is a volumetric screw feeder used for the metering of dry solids into a process.

69. The apparatus of claim 68 wherein the rate of delivery of the combustible and non-combustible powder is controlled by a screw conveyor driven by a variable speed motor.

70. The apparatus of claim 46 wherein the rate of delivery of the combustible and non-combustible powder is controlled by means of a variable valve which controls a gas carrier.

71. The apparatus of claim 70 wherein the gas carrier is air, oxygen or a combination of the two.

72. The apparatus of claim 68 wherein the output of the screw feeder is in fluid communication with the container holding the combustible and non-combustible powders.

73. The container of claim 68 wherein the container holding the combustible and non-combustible powders is sealed from atmospheric pressure.

74. The combustion chamber of claim 46 wherein the combustion chamber is cylindrical in shape, is formed from two concentric shells with the space between the shells fully enclosed and in fluid communication with the central portion of the combustion chamber.

75. The apparatus of claim 74 wherein one end of the combustion chamber is closed to prohibit the exhaust of the combustion products and one end is open to permit the exhaust of the combustion products.

76. The apparatus of claim 75 wherein the supply line injects one or more metallic combustible powders, one or more non-combustible materials and an oxidizer into the space between the inner and outer shells of the combustion chamber to causes a forward vortex to form in the space between the inner and outer shells of the combustion chamber wherein the vortex travels in the direction from the closed end to the open end of the combustion chamber.

77. The combustion chamber of claim 76 wherein the forward vortex is in fluid communication with the central portion of the combustion chamber and causes a reverse vortex to flow circumferentially along the inside surface of the central portion of the combustion chamber and to travel in the direction from the open end to the closed end of the combustion chamber.

78. The apparatus of claim 75 wherein the supply line injects one or more metallic combustible powders, one or more non-combustible materials and an oxidizer into the closed end of the combustion chamber.

79. The apparatus of claim 75 wherein the supply line injects a portion of the metallic combustible powders and non-combustible materials and the oxidizer into the closed end of the combustion chamber and the remainder of the metallic combustible powders and non-combustible materials and oxidizer into the space between the inner and outer walls of the combustion chamber.

80. The apparatus of claim 79 wherein that portion of the combustible powder and non-combustible materials and oxidizer that is injected into the space between the inner and outer walls of the combustion chamber causes a forward vortex of gas and materials which flows circumferentially from the closed end towards the open end of the combustion chamber.

81. The combustion chamber of claim 75 wherein the igniter is located on the central axis of the combustion chamber and at the closed end.

82. The combustion chamber of claim 75 wherein the flame from the igniter is directed tangential to the surface of the inner wall of the central portion of the combustion chamber and in proximity to the open end of the combustion chamber.
